(19) United States
(12) Patent Application Publication
(10) Pub. No.: US 2015/0092905 A1
(43) Pub. Date: Apr. 2, 2015

(54) Feed water distributing system for a nuclear power plant, and method for operating a nuclear power plant

(71) Applicant: AREVA GMBH, Erlangen (DE)

(72) Inventors: ANDREAS LEMM, NUERNBERG (DE); KONRAD SCHRAMM, ERLANGEN (DE)

(21) Appl. No.: 14/515,953

(22) Filed: Oct. 16, 2014

Related U.S. Application Data
(63) Continuation of application No. PCT/EP2013/052324, filed on Feb. 6, 2013.

(30) Foreign Application Priority Data
Apr. 16, 2012 (DE) 10 2012 007 411.5

(51) Int. Cl. G21C 15/02

(52) U.S. Cl. CPC G21C 15/02
USPC 376/395

(57) ABSTRACT

A feed water distributing system for a nuclear power plant contains feed water distributers disposed within a reactor pressure vessel. The feed water distributing system has a consistent feed water distribution when starting up and during a partial load operation with low mechanical loads and has a redundancy of the individual components while maintaining the customary level of reliability in nuclear power plants. Each feed water distributer has exactly one annular main body with an inner channel, at least one fill socket which is fluidically connected to the inner channel via at least one fill opening, and a plurality of outlet nozzles which are fluidically connected to the inner channel. Each of the fill sockets of one feed water distributer is fluidically connected to each outlet nozzle of the feed water distributer.

### CROSS-REFERENCE TO RELATED APPLICATION

This is a continuation application, under 35 U.S.C. §120, of copending international application No. PCT/EP2013/052324, filed Feb. 6, 2013, which designated the United States; this application also claims the priority, under 35 U.S.C. §119, of German patent application No. DE 10 2012 007 411.5, filed Apr. 16, 2012; the prior applications are herewith incorporated by reference in their entireties.

### BACKGROUND OF THE INVENTION

### Field of the Invention

The invention relates to a feed water distributing system for a nuclear power plant, composed of at least two feed water distributors arranged inside a reactor pressure vessel, and to a method for operating a nuclear power plant. It relates, furthermore, to a nuclear power plant.

In a nuclear power plant, heat is generated as a result of controlled nuclear fission in a reactor core which is located in a reactor pressure vessel. By means of this heat, a coolant is heated, which is pumped through the reactor core and thereby transports away the energy from the reactor core and the reactor pressure vessel. On account of the radioactivity which is hazardous to humans, as a rule, in addition to the reactor pressure vessel, further screens or protective shields are located in the nuclear power plant in order to absorb a large part of the radioactive radiation.

There are various reactor types which differ from one another in terms of nuclear fuel, cooling circuit and modulator.

In boiling water reactors, which are of the light water reactor type, there is a single steam/water circuit, in contrast to pressurized water reactors in which there is a separate primary and secondary circuit. As a rule, in boiling water reactors, preheated water is pumped into the reactor pressure vessel. As a result of the heat which arises there, the water is conducted as steam out of the reactor pressure vessel, drives one or more turbines there and is condensed out. It is subsequently fed back into the reactor pressure vessel by pumping. As a rule, the infeed is preceded by a feed water tank in which the fluid is first collected for the purpose of temperature and/or pressure compensation. In most cases, moreover, the water, before being fed in, runs through a preheater in order to approximate the temperature of the condensed water to the temperature in the reactor pressure vessel.

For the distribution of water in the reactor pressure vessel itself, a feed water distributing system, system in brief, having a feed water distributor is provided. In a system customary in the applicant's company, the feed water distributor is composed of exactly one ring-shaped main body which is subdivided into two or four hollow subsegments. In the case of four subsegments, each of the subsegments extends essentially over a quarter circle and is flow-connected in each case to an infeed connection piece and a plurality of outlet nozzles. The infeed connection pieces, as a rule, are distributed symmetrically, so that in each case two infeed connection pieces are arranged opposite one another in the reactor pressure vessel. In the case of four infeed connection pieces, a cross-shaped pattern is therefore formed. The two or four subsegments of the feed water distributor are filled with water by the same number of feed lines, each of these feed lines and therefore the subsegments of the feed water distributor being connectable separately. In addition to the use of water in the reactor, other fluids which are fed into the reactor pressure vessel by the feed water distributor may also be envisaged. The term “feed water” is therefore to be interpreted broadly below and also embraces cases of this kind.

The feed water distributing system is to ensure a sufficiently large quantity of feed water is supplied in the reactor pressure vessel, so that, inter alia, circulation can also be established by virtue of the pressure prevailing there and reactor heat can be discharged.

Since the feed water distributor customary in the applicant's company is configured for full-load operation, the sizes of feed lines, filler connection pieces and main bodies, etc. are selected such that suitable feeding of the reactor pressure vessel takes place in full-load operation. However, in part-load operation and when the nuclear reactor is started up, the reactor has to be supplied by a lower throughput of feed water. Since, for the suitable use of a feed water distributor, inter alia, a minimum pressure must prevail in the latter, in such a case the feed lines are utilized only partially, and this may take place by active control or by passive components. If, for example, the fluid flows through only one of the feed lines present and therefore also through only one of the subsegments, however, this also means that, because of the ring-shaped arrangement, the fluid is no longer distributed uniformly in the reactor pressure vessel, but instead asymmetrically.

An asymmetric feed entails serious disadvantages. On the one hand, between directly fed and non-fed locations in the reactor pressure vessel, high temperature differences may occur which may lead to material fatigue and fractures, in particular in the inner wall of the reactor pressure vessel. On the other hand, an uneven feed may also cause parts of the reactor heat to be discharged with delay, so that, on the one hand, efficiency losses are to be expected and, on the other hand, absolute temperatures which are too high may occur in subregions of the reactor pressure vessel. Also in the case of nuclear reactor overloads, which may occur, inter alia, when there is a threat of a core meltdown, such a system has disadvantages, since the size ratios are configured to only a limited extent for this situation, and therefore, as a rule, additional emergency cooling elements are used. A further disadvantage is the lack of genuine redundancy. For example, in the event of a failure of a feed line and/or of a feed water distributor, the feeding of the reactor core with feed water is persistently uneven until the defect is rectified.

### SUMMARY OF THE INVENTION

The object on which the invention is based is, therefore, to specify a feed water distributing system which, on the one hand, during start-up and in part-load operation, provides uniform distribution of the feed water, along with lower mechanical loads, and, on the other hand, while preserving the level of safety conventional in nuclear power plants, has redundancy of the individual components. Furthermore, a method, especially suitable by virtue of the use of such a feed water distributing system, for operating a nuclear power plant is to be specified.

As regards the feed water distributing system, the object is achieved, according to the invention, in that each feed water distributor has exactly one ring-shaped main body with an internal duct, has at least one filler connection piece which is flow-connected to the internal duct via at least one filler orifice, and has a multiplicity of outlet nozzles which are flow-connected to the internal duct, and each of the filler connection pieces of a feed water distributor is flow-connected to each outlet nozzle of this feed water distributor.

Advantageous refinements are the subject matter of the subclaims.

The invention is based on the notion that a smaller quantity of feed water is necessary during the start-up and in part-load operation than in full-load operation. Moreover, in the event of partial failures of the feed water system, the feeding of the reactor core has to be maintained and the feed water should be distributed as uniformly as possible in the reactor pressure vessel. The individual subsegments of a hitherto customary feed water system, which has a plurality of hollow bodies separate from one another in a feed water distributor, are configured such that these require a specific fluid throughput and specific pressure. However, for example when the reactor is started up, the feed water demand is lower, and therefore only individual subsegments are regularly used. On account of the different temperatures in the subsegments, which are also the result of asymmetric filling, mechanical loads may occur which may also be conducive to the formation of cracks.

According to the invention, it was recognized that a feed water distributor may also be composed of one continuous hollow main body of a feed water distributor, in which all the outlet nozzles are flow-connected to the filler connection piece or filler connection pieces. As a result, uniform symmetrical feeding of the reactor core can take place by a single feed water distributor. In a targeted refinement of a feed water distributor, this may be configured such that it is suitable for part-load operation. Since the quantity of feed water is higher in full-load operation, there is provision whereby the feed water distributing system is composed of at least two such feed water distributors. During start-up or in part-load operation, one feed water distributor is therefore sufficient which distributes the feed water symmetrically. Since this has a continuous internal duct, asymmetric heat distribution caused by the feed water supplied is also avoided in the feed water distributor itself, with the result that lower mechanical loads may occur. In the case of a higher demand for feed water, a second feed water distributor is connected actively or passively and likewise feeds homogeneously. Also, in the case of a demand for feed water which exceeds normal full-load operation, it is conceivable that further feed water distributors can be connected via the number of feed water distributors provided for full-load operation, so that feeding can be afforded for emergency situations where cooling which exceeds the cooling demand in full-load operation becomes necessary. By virtue of the targeted design of the feed water distributing system with a plurality of feed water distributors which are filled independently of one another and which each independently perform a homogeneous feed, a redundancy of the system is also afforded which assists in continuing to operate the nuclear power plant in the event of partial failures or damage.

In order to achieve an especially homogeneous distribution of the feed water, there is provision, in an advantageous refinement, whereby the outlet nozzles are distributed uniformly over the main body of the respective feed water distributor, as seen in the circumferential direction.

For homogeneous feeding of a conventional reactor pressure vessel in boiling water reactors, in an advantageous refinement each feed water distributor has between forty and fifty outlet nozzles, since, inter alia, the properties of the outlet nozzles and of a conventional reactor pressure vessel are thereby taken into account.

In order to achieve as high a stability of a feed water distributor as possible, in an advantageous refinement the main body of each feed water distributor has generally a circular cross section. Thus, as a rule, high stability is linked to a circular cross section. Moreover, the outer surface of the feed water distributor, the outer surface being in contact with the steam in the reactor pressure vessel, is small, as compared with many other forms of construction, and therefore thermal load upon the feed water distributor is kept low.

For a redundant configuration of the system in which each feed water distributor feeds the reactor pressure vessel homogeneously, in an advantageous refinement there is provision whereby the main bodies of the feed water distributors are arranged one above the other. As a result, these cover essentially the same region of the reactor pressure vessel, so that, in the event of failure of a feed water distributor, another can assume its function. Also, when the feed by one feed water distributor is changed over to two or more feed water distributors, a homogeneous feed is possible by each feed water distributor when it has a suitably configured form. Also, in such a stacked type of construction, the inner space of the reactor pressure vessel can be suitably utilized.

In order, in particular, to supply the bottom region of the reactor pressure vessel with feed water, in an advantageous refinement all the nozzle orifices of the outlet nozzles of at least one feed water distributor are directed toward the bottom of the reactor pressure vessel. As a result of such orientation, the feed water is preferentially steered in the direction of the bottom, so that, particularly in the liquid state, it can reach the bottom region in an especially suitable way. Moreover, by virtue of the nozzle orientation, a temporary overpressure is generated in the bottom region, so as to benefit a commencing of circulation of the feed water or steam which is conducted away through extraction orifices which, as a rule, are formed in the upper region of the reactor pressure vessel.

In order to cope with spatial limitations in the reactor pressure vessel and in the feed water supply lines leading to the reactor pressure vessel, in an advantageous refinement the feed water distributing system has between two inclusive and four inclusive feed water distributors. Since at least two feed water distributors are provided for full-load operation, but, on the other hand, the number of feed water distributors is limited, inter alia, because of necessary lead-throughs, sometimes constituting weak points, through the walls of the reactor pressure vessel, it has been shown that a number of between two and four feed water distributors suitably takes both factors into account.

Particularly for the configuration of the feed water distributing system also as an emergency system, as further intended, in an advantageous refinement the feed water distributing system has more than two feed water distributors. By such a number of feed water distributors, it is possible, for example, to use exactly one feed water distributor in part-load operation and exactly two feed water distributors in full-load operation. In an emergency which requires intensified cooling, therefore, at least one further feed water distributor can be connected, which likewise introduces the feed water into the reactor pressure vessel homogeneously. Also, in this case, a failure of one of the feed water distributors can be compensated.

In order to ensure the stability of each feed water distributor and to fasten this in a suitable way, in an advantageous refinement each main body has holding elements, by which the main body is fastened to the inner wall of the reactor pressure vessel. Particularly as a result of such fastening, on the one hand, the modular nature of the feed water distributing system is promoted. For example, in the event of defects, only individual parts therefore can be exchanged. On the other hand, temperature differences between the main body and the inner wall of the reactor pressure vessel are also taken into account, since, in a further function, a holding element can perform a thermal buffer function.

In order to promote a symmetrical mechanical load as a consequence of temperature differences between various components in the reactor pressure vessel, in an advantageous refinement the holding elements on the main body of each feed water distributor are arranged symmetrically about a filler orifice in the main body or about a filler connection piece. In particular, since heat is transported via the filler connection pieces or the filler orifices connected to these and is transferred to the surrounding components, the components should be constructed identically so as also to experience an identical or at least similar load. Since the connection to the inner wall of the reactor pressure vessel and consequently the holding elements, on the one hand, are in many cases weak points and, on the other hand, themselves constitute thermal connections between the main body and the inner wall of the reactor pressure vessel, it is desirable that these holding elements are distributed such that mechanical loads act uniformly.

In order to provide a small number of lead-throughs through the reactor pressure vessel, in an advantageous refinement each feed water distributor has exactly one filler connection piece. On the one hand, lead-throughs through the reactor pressure vessel are complicated and therefore entail costs. On the other hand, they often constitute weak points. In particular, the conduction of feed water which has a temperature other than that of the inner wall of the reactor pressure vessel is exposed to mechanical loads. It is therefore desirable to keep the number of lead-throughs small. The filler connection piece is directly adjacent to the feed line or to the lead-through and is flow-connected to the orifice or orifices in the feed water distributor, so that it is desirable to use a filler connection piece as a counterpart to a lead-through. Moreover, the filler connection piece constitutes a thermal connection between the main body and the inner wall of the reactor pressure vessel, with the result that mechanical stresses may be triggered, but these can be avoided.

For an especially suitable distribution of the feed water in the internal duct of the main body, in an advantageous refinement each main body has two filler orifices for the filler connection piece. On account of the ring-shaped configuration of the main body, symmetrical feeding of the main body is desirable, so that the feed water is distributed uniformly in the internal duct. In the case of a filler orifice, this means that ideally one half of the fed-in feed water is transported toward one side of the main body and the other half is transported toward the other side of the main body. In order to achieve this, a symmetrical feed through the filler orifices which is already pointed in the respective directions of the internal duct affords effective assistance. In an especially advantageous refinement, the internal duct of each main body is additionally interrupted between the two filler orifices, for example by a partition. Particularly as a result of such an interruption, the feed water is distributed symmetrically in the internal duct, so that symmetrical feeding of the reactor pressure vessel is promoted.

In an advantageous refinement, a nuclear reactor has one of the feed water distributing systems described, in order during operation, on the one hand, to promote feeding of the reactor pressure vessel which in most cases is symmetrical and, on the other hand, to make it possible to have a redundancy of the components of the feed water distributing system.

As regards the method for operating a nuclear power plant, the object mentioned further above is achieved, according to the invention, in that the nuclear power plant has one of the feed water distributing systems described, in which exactly one feed water distributor is used in start-up operation and more than one feed water distributor is used in full-load operation.

By virtue of such a sequence, especially symmetrical feeding of the reactor pressure vessel can be achieved, taking into account the quantity of feed water necessary in each case. Since a smaller quantity of feed water is necessary during the start-up and in part-load operation of the reactor, only a smaller quantity of feed water has to be distributed. Using the feed water distributing system, in such an operating mode an especially effective infeed can be achieved by the use of exactly one feed water distributor. In other operating situations, such as full-load operation, a larger quantity of feed water is required in order to transport away the reactor heat. An effective provision of the quantity of feed water and its distribution can be achieved by the use of two feed water distributors. Since the feed water distributors can be configured in terms of their dimensions such that a symmetrical feed takes place effectively, during start-up, by one feed water distributor and, in full-load operation, by two feed water distributors, such a method for operating the nuclear power plant constitutes, in particular, an effective utilization of the system.

The advantages achieved by the invention are, in particular, that, on the one hand, symmetrical feeding of a reactor pressure vessel becomes possible in many different operating modes by the use of at least two ring-shaped or toroidal feed water distributors. On the other hand, this system, by virtue of its repeated symmetrical configuration, has redundancy which, in particular, takes into account the concept of safety in nuclear power plants. Also, mechanical loads, which may occur due to the transmission of heat and may promote the formation of cracks in the feed water distributing system or the reactor pressure vessel, can be reduced. Moreover, because of the modular nature of the system and of its feed water distributors, an exchange of defective components is made easier.

Other features which are considered as characteristic for the invention are set forth in the appended claims.

Although the invention is illustrated and described herein as embodied in a feed water distributing system for a nuclear power plant, and a method for operating a nuclear power plant, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal sectional view of a reactor pressure vessel which has a feed water distributing system according to the invention;

FIG. 2 is a diagrammatic, perspective view of the feed water distributing system which is composed of two feed water distributors; and

FIG. 3 is a cross-sectional view of two cylindrical main bodies, arranged one above the other, of two feed water distributors.

### DETAILED DESCRIPTION OF THE INVENTION

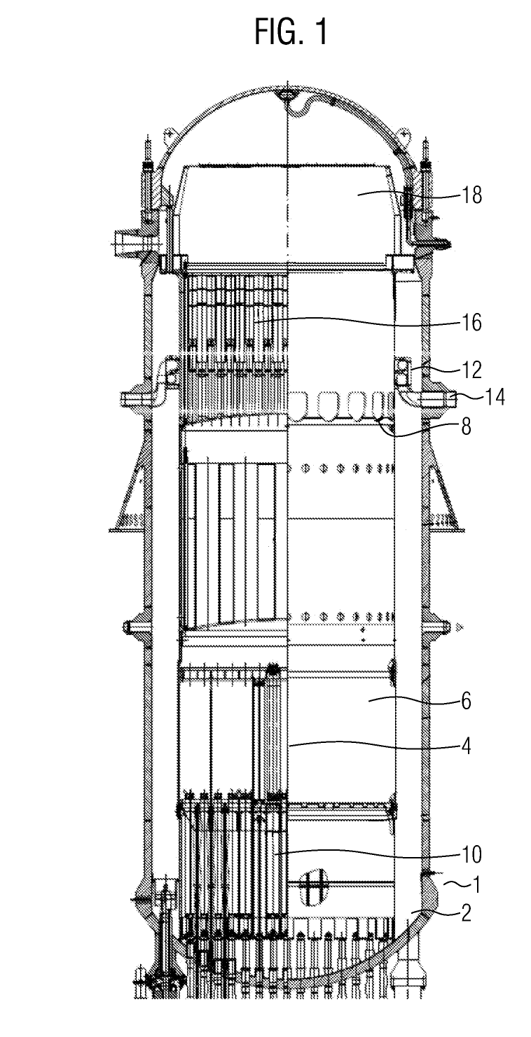

Identical parts are given the same reference symbols in all the figures. Referring now to the figures of the drawings in detail and first, particularly to FIG. 1 thereof, there is shown a reactor pressure vessel 1, a lower subregion of which is also designated as a reactor bottom 2. Located in the reactor pressure vessel 1 is the reactor core 4 which is itself surrounded by a core shroud 6. The reactor core 4, as a rule, is covered upwardly by a core shroud cover 8. The radioactive decay and consequently heat occurring in the reactor core 4 are controlled by control rods 10. The feed water, which is heated by the reactor core 4 and serves for transporting away the heat, is fed into the reactor pressure vessel 1 by a feed water distributing system 12. The feed water is in this case introduced from outside through supply lines 14 into the reactor pressure vessel 1 and is subsequently distributed in the reactor pressure vessel 1 via the feed water distributing system 12. On account of the chosen arrangement of the feed water distributing system 12 and the reactor core 4, it is beneficial to conduct the feed water out of the feed water distributing system 12 downward. As a result, the feed water, which has a lower temperature than the reactor core 4, impinges upon the reactor core 4, is heated there, so that overpressure occurs, and is then discharged via steam separators 16 which are arranged in the upper region of the reactor pressure vessel 1. The heated steam or the fluid drives turbines which are located outside the reactor pressure vessel 1, condenses and is subsequently fed into the reactor pressure vessel 1 again as feed water by pumps. The feed water distributing system 12 is in this case fastened to the inner wall of the reactor pressure vessel 1.

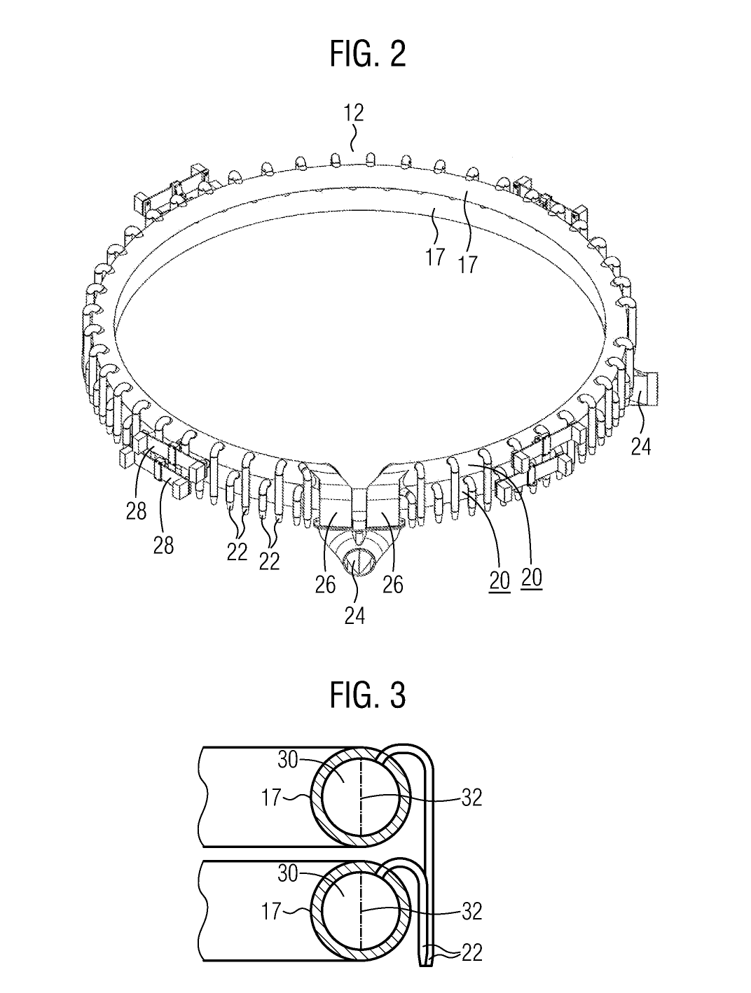

FIG. 2 illustrates a preferred design variant of the feed water distributing system 12. This contains two cylindrical main bodies 17 which are in each case bent into a 360° ring and which have in each case an internal duct 30. The internal duct 30 is in this case connected to each outlet nozzle 22 of a feed water distributor 20. If, then, feed water is conducted into a feed water distributor 20 via an inlet connection piece 24 and via two inlet orifices 26 flow-connected to this, the feed water is distributed uniformly in the feed water distributor 20 and flows through the outlet nozzles 22 in the reactor pressure vessel 1.

The two generally ring-shaped or toroidal feed water distributors 20 are in this case arranged one above the other in the installation position, so that they both bring about similar symmetrical feeding of the reactor pressure vessel 1 and therefore also of the reactor core 4. By virtue of the targeted orientation of the outlet nozzles 22 downward and therefore into the region of the reactor bottom 2, in particular, the reactor core 4 is supplied with feed water. By the inlet connection pieces 24 of each feed water distributor 20 being rotated with respect to one another, the necessary lead-throughs in the reactor pressure vessel 1 are arranged at different locations, so that, in the event of cracks in subregions, it is possible for feed water to continue to be supplied. In the arrangement shown here, the angle of rotation amounts to approximately 90°, as a result of which the supply of feed water into the feed water distributing system 12 takes place redundantly by two supply systems which act independently of one another and are arranged outside the reactor pressure vessel 1.

The two feed water distributors 20 are in this case fastened to the inner wall of the reactor pressure vessel 1 via holding elements 28. Since different holding elements 28 are used for each feed water distributor 20, the feed water distributors can be mounted in a floating manner with respect to one another. Thus, in the case of mechanical loads which act only upon one feed water distributor 20, the load is not transferred to the other feed water distributor 20. Particularly in the region of the inlet connection pieces 24 and the filler orifices 26, mechanical loads arise on account of the different temperatures of the individual components and of the feed water. Thus, particularly by virtue of the targeted modular type of construction of the individual feed water distributors 20, safety-relevant redundancy of the feed water distributing system 12 is achieved.

On account of an interruption in the ring-shaped main body 17 of the feed water distributor 20 in the region of the two filler orifices 26, a targeted transfer of the feed water is achieved in the main body 17. Ideally, approximately one half of the feed water flows into a left subregion and the other half into a right subregion, from where they are fed into the reactor pressure vessel 1 via the outlet nozzles 22, so that a homogeneous distribution can be achieved.

To operate a nuclear power plant, only one of the two feed water distributors 20 need be used when the reactor core 4 is started up, during which a smaller quantity of heat is released than in full-load operation. In this case, too, the fed-in feed water is distributed homogeneously in the reactor pressure vessel 1. In full-load operation, in which a larger quantity of heat is released and therefore greater cooling is necessary, the second feed water distributor 20 can be connected. In this case, too, a homogeneous feed is possible by the feed water distributing system 12.

Two cylindrical main bodies 17, arranged one above the other, of two feed water distributors 20 are shown in cross section in FIG. 3. The feed water flows through the internal duct 30 of each cylindrical main body 17, is first distributed in the respective cylindrical main body 17 and is subsequently conducted through the outlet nozzles 22 into the reactor pressure vessel 1, the two feed water distributors 20 acting independently of one another.

The following is a summary list of reference numerals and the corresponding structure used in the above description of the invention:
1 Reactor pressure vessel
2 Reactor bottom
4 Reactor core
6 Core shroud
8 Core shroud cover
10 Control rod
12 Feed water distributing system
14 Supply line
16 Steam separator
17 Main body
20 Feed water distributor
22 Outlet nozzle
24 Filler connection piece
26 Filler orifice
28 Holding element
30 Internal duct
32 Cross section

1. A feed water distributing system for a nuclear power plant, comprising:
at least two feed water distributors disposed inside a reactor pressure vessel, each of said feed water distributors containing:
exactly one ring-shaped main body with an internal duct formed therein;
at least one filler orifice;
at least one filler connection piece flow-connected to said internal duct via said at least one filler orifice; and
a plurality of outlet nozzles flow-connected to said internal duct, and each said filler connection piece of said feed water distributors being flow-connected to each of said outlet nozzles of a respective one of said feed water distributors.

2. The feed water distributing system according to claim 1, wherein said outlet nozzles of each of said feed water distributors being distributed uniformly over said ring-shaped main body of said respective feed water distributor, as seen in a circumferential direction.

3. The feed water distributing system according to claim 1, wherein each of said feed water distributors has between forty and fifty of said outlet nozzles.

4. The feed water distributing system according to claim 1, wherein said ring-shaped main body of each of said feed water distributors has a generally circular cross section.

5. The feed water distributing system according to claim 1, wherein said main body of each of said feed water distributors is disposed one above the other.

6. The feed water distributing system according to claim 1, wherein said outlet nozzles have nozzle orifices and all of said nozzle orifices of at least one of said feed water distributors is directed toward a bottom of the reactor pressure vessel.

7. The feed water distributing system according to claim 1, wherein said feed water distributors are two inclusive feed water distributors.

8. The feed water distributing system according to claim 1, wherein more than two of said feed water distributors are formed.

9. The feed water distributing system according to claim 1, further comprising holding elements, each said ring-shaped main body is fastened to an inner wall of the reactor pressure vessel by said holding elements.

10. The feed water distributing system according to claim 9, wherein said holding elements on said ring-shaped main body of each of said feed water distributors are disposed symmetrically about said filler orifice in said ring-shaped main body or about said filler connection piece.

11. The feed water distributing system according to claim 1, wherein each of said feed water distributors has exactly one said filler connection piece.

12. The feed water distributing system according to claim 11, wherein said at least one filler orifice is one of two said filler orifices, each said ring-shaped main body has said two filler orifices for said filler connection piece.

13. The feed water distributing system according to claim 12, wherein said internal duct of each said ring-shaped main body being interrupted between said two filler orifices.

14. The feed water distributing system according to claim 1, wherein said at least two feed water distributors are two of four inclusive feed water distributors.

15. A nuclear reactor, comprising:
a reactor pressure vessel; and
a feed water distributing system having at least two feed water distributors disposed inside said reactor pressure vessel, each of said feed water distributors containing:
exactly one ring-shaped main body with an internal duct formed therein;
at least one filler orifice;
at least one filler connection piece flow-connected to said internal duct via said at least one filler orifice; and
a plurality of outlet nozzles flow-connected to said internal duct, and each said filler connection piece of said feed water distributors being flow-connected to each of said outlet nozzles of a respective one of said feed water distributors.

16. A method for operating a nuclear power plant having the feed water distributing system according to claim 1, which comprises the steps of:
using exactly one of the feed water distributors in a start-up operation; and
using more than one of the feed water distributors during full-load operation.
